(19) United States
(12) Patent Application Publication
(10) Pub. No.: US 2010/0326417 A1
(43) Pub. Date: Dec. 30, 2010

(54) COLLAPSIBLE GAS GRILL

(75) Inventors: Kevin GROTH, Charlottesville, VA (US); R. James Foster, Rogersville, TN (US); Mark T. Proffitt, Greeneville, TN (US)

Correspondence Address: MCGUIREWOODS, LLP, 1750 TYSONS BLVD, SUITE 1800, MCLEAN, VA, 22102, US

(73) Assignee: Meco Corporation, Greeneville, TN (US)

(21) Appl. No.: 12/822,528

(22) Filed: Jun. 24, 2010

Related U.S. Application Data
(60) Provisional application No. 61/219,925, filed on Jun. 24, 2009.

(51) Int. Cl. A47J 37/07; F24C 3/08; B23P 11/00

(52) U.S. Cl. 126/25 R; 126/39 E; 29/428

(57) ABSTRACT

A collapsible gas grill having a control panel, a bowl and a hood. The collapsible gas grill comprises a cooking grid that supports a cooking item, a burner attached to the bowl, a valve attached to the control panel, a rotating latch that locks the hood to the bowl, a base that supports the grill, and a catch that engages the base when the collapsible gas grill is in one of a collapsed configuration or an open configuration.

### CROSS REFERENCES TO PRIOR APPLICATIONS

This application claims priority and the benefit thereof under 35 U.S.C. §119(e) from U.S. Provisional Application No. 61/219,925, filed on Jun. 24, 2009, titled “Collapsible Gas Grill,” the entire contents of which are hereby incorporated herein by reference.

### FIELD OF THE DISCLOSURE

The disclosure relates to a multi-purpose heating apparatus. More particularly, the disclosure relates to a collapsible gas grill that may be used to heat or cook items, such as, for example, meat, fish, vegetables, fruits, nuts and the like.

### BACKGROUND OF THE DISCLOSURE

Cooking with natural gas or propane is ubiquitous throughout many households. Many people prefer cooking over a gas flame. Gas cooking appliances such as stoves, grills, and the like, provide a quick, clean and easy way to heat or cook foods. The availability of controllable gas valves provides for effective, reliable and predictable cooking of foods using gas burners.

A method and apparatus for providing a portable preassembled grill is described in U.S. Pat. No. 6,439,221, issued Aug. 27, 2002, to Eric A. Ward et al. The patent discloses a grill having two pairs of pivoting legs which collapse and have wheels at one end. The disclosed grill is configured for easy shipping, consumer handling, and storage by the consumer, without needing tools to assemble (or disassemble) the grill.

An unfulfilled need exists for a versatile walkabout gas grill that may be used for cleanly, effectively and efficiently cooking foods, such as, for example, but not limited to, meats, fish, vegetables, fruits, nuts, and the like.

### SUMMARY OF THE DISCLOSURE

A collapsible gas grill is provided that comprises a hood, a bowl, a base and a control panel. The collapsible gas grill is portable and can be easily transported and stored. When collapsed, a handle at one end and wheels at the other end make it east to transport. Nested legs help the grill fold flat. The handle and a loop on one of the legs increase the hanging storage options.

According to an aspect of the disclosure, a collapsible gas grill is disclosed having a control panel, a bowl and a hood. The collapsible gas grill comprises: a cooking grid that supports a cooking item; a burner attached to the bowl, the burner being configured to provide heat to the cooking grid, the burner being attached to the bowl; a valve attached to the control panel, the valve being configured to control supply of gas to the burner; a rotating latch that locks the hood to the bowl; a base that supports the grill; and a catch that engages the base when the collapsible gas grill is in one of a collapsed configuration or an open configuration, wherein the catch and gate is coupled to the rotating latch. The base may comprise a plurality of legs configured to collapse substantially parallel with a surface plane of the bowl. The burner may comprise a longitudinal burner that is configured to rigidly attach to an inner wall of the bowl. The longitudinal burner may comprise: an inlet portion that is configured to receive gas supply from a valve; a tubular portion that is configured to receive gas supply from the inlet portion and release gas through a plurality of orifices; and a flat portion that is configured to be attached to an inner wall of the bowl. The plurality of legs may comprise: a pivoting set of legs that are coupled to a first portion of the bowl; and a releasable set of legs that are configured to engage the catch. The releasable set of legs may comprise an upper portion and a cross-member, the upper portion being configured to engage the catch when the collapsible gas grill is in the open configuration, and the cross-member being configured to engage the catch when the collapsible gas grill is in the collapsed configuration. The control panel may include a handle.

The collapsible gas grill may further comprise a gate that secures the base to the catch when the collapsible gas grill is in one the collapsed configuration or the open configuration.

According to a further aspect of the disclosure, a collapsible gas grill is disclosed having a bowl and a hood. The collapsible gas grill comprises: a burner rigidly affixed to the bowl; and a plurality of legs configured to collapse substantially parallel with a surface plane of the bowl. The collapsible gas grill may further comprise a control panel that includes a handle. The burner may comprise a longitudinal burner that is configured to rigidly attach to an inner wall of the bowl. The collapsible gas grill may further comprise a rotating latch configured to lock the hood to the bowl. The collapsible gas grill may further comprise a catch that is configured to receive either a portion of one of the plurality of legs or a cross-bar member, wherein the catch is coupled to the rotating latch. The plurality of legs may comprise: a pair of pivoting legs that are attached to a side of the bowl; and a pair of releasable legs that are configured to engage the catch. The longitudinal burner may comprise: an inlet portion that is configured to receive gas supply from a valve; a tubular portion that is configured to receive gas supply from the inlet portion and release gas through a plurality of orifices; and a flat portion that is configured to be attached to an inner wall of the bowl. The collapsible gas grill may further comprise a regulator that is configured to supply gas from a gas supply source to the valve. The collapsible gas grill may further comprise a flavor activator that is attached to at least one of the burner and an inner wall of the bowl.

According to a further aspect of the disclosure, a method is disclosed for providing a collapsible gas grill. The method comprises: providing a bowl having front and rear portions; affixing a control panel to the bowl; pivotally attaching the bowl to a first set of legs; pivotally attaching a second set of legs to the first set of legs; providing a loop on an upper portion of the second set of legs; and providing a catch on the rear portion of the bowl to engage the loop, wherein the first set of legs and the second set of legs are configured to collapse into a position substantially parallel with a surface plane of an underside of the bowl when the collapsible grill is configured in a collapsed configuration. The method may further comprise: affixing a longitudinal burner to an inner wall of the bowl; and coupling the longitudinal burner to a valve. The method may further comprise a rotating latch that is configured to lock a hood to the bowl.

Additional features, advantages, and embodiments of the disclosure may be set forth or apparent from consideration of the following detailed description and drawings. Moreover, it is noted that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIGS. 1A-1D show various views an example of a collapsible gas grill, according to principles of the disclosure;

FIG. 2 shows a perspective top-front view of the collapsible gas grill of FIG. 1;

FIG. 3 shows a top view of an example of a bowl for use with the collapsible gas grill of FIG. 1, according to principles of the disclosure;

FIG. 4 shows a top view of the bowl in FIG. 3 with a plurality of flavor activators, according to principles of the disclosure;

FIG. 5 shows a perspective side view of an example of a control panel and burners that may be used in the collapsible gas grill of FIG. 1, according to principles of the disclosure;

FIG. 6 shows a perspective side view of the example of the control panel and burners shown in FIG. 5, with a portion of the control panel housing removed;

FIG. 7 shows a perspective side view of the example of the control panel and burners shown in FIGS. 5 and 6, with the control panel housing removed;

FIG. 8 shows a perspective view of an example of a longitudinal burner that may be used with the collapsible gas grill shown in FIG. 1, according to principles of the disclosure;

FIG. 9 shows a top view of the longitudinal burner FIG. 8; and

FIG. 10 shows a side view of the longitudinal burner of FIG. 8.

The present disclosure is further described in the detailed description that follows.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

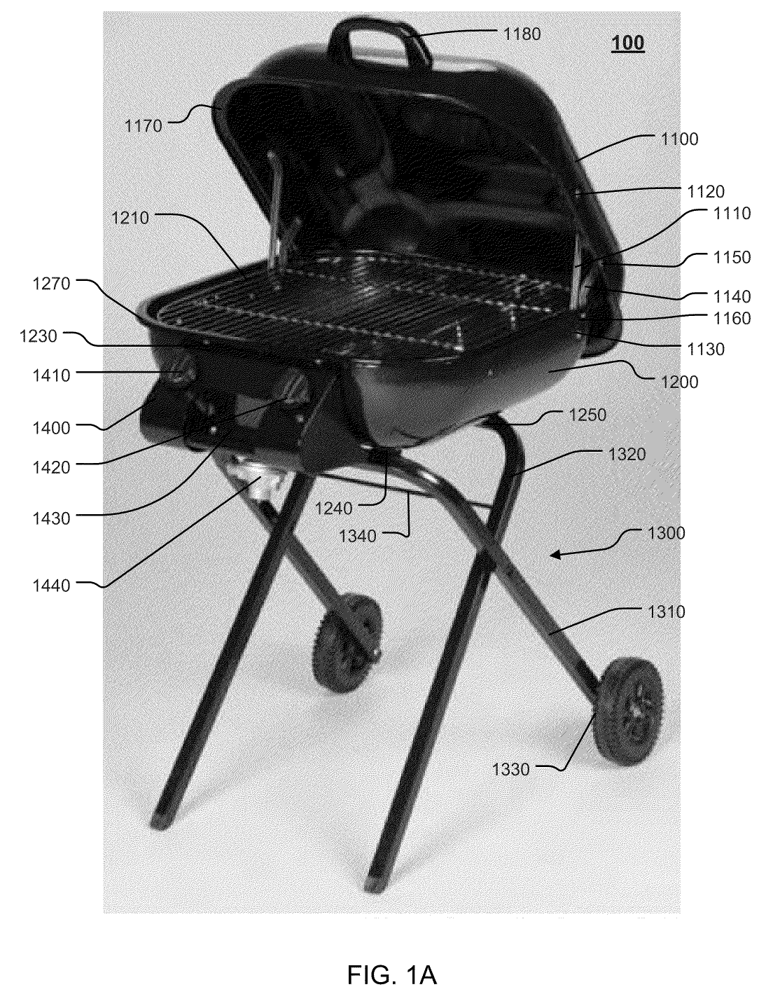

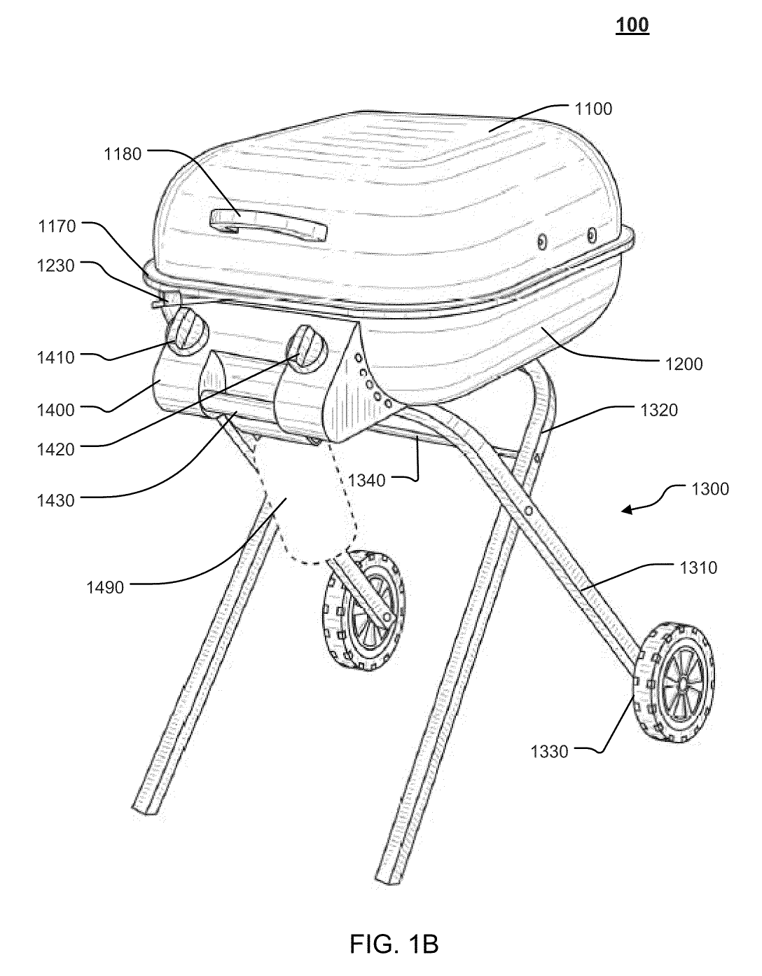

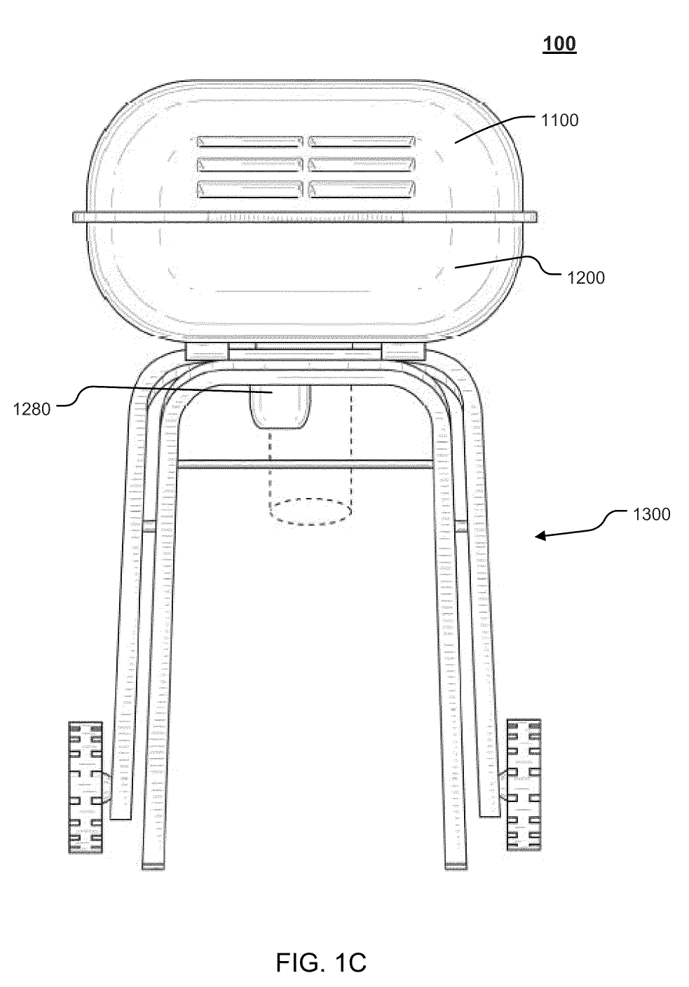

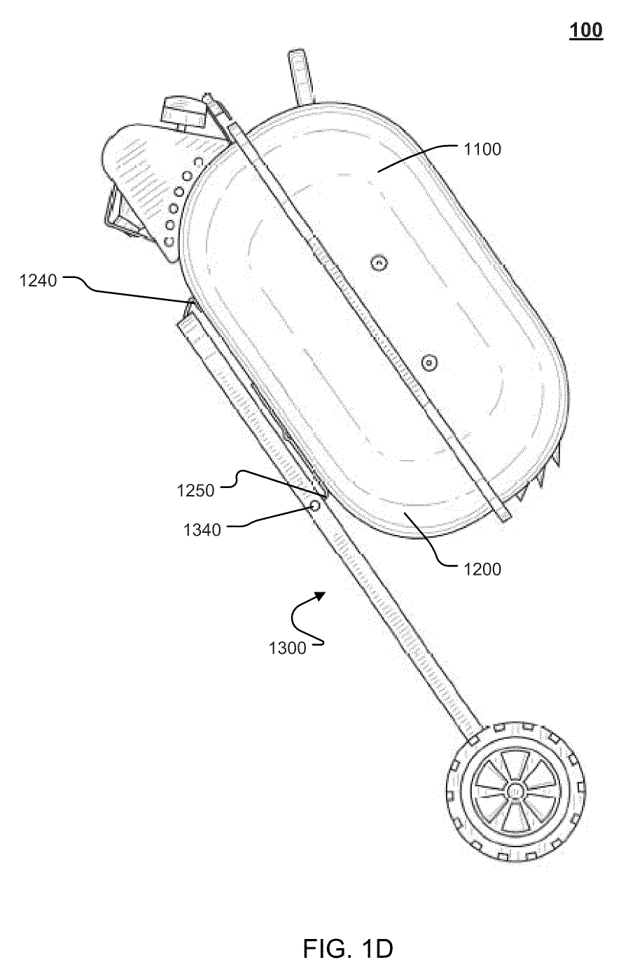

FIGS. 1A-1D show various views of an example of a collapsible gas grill 100. In particular, FIG. 1A shows a perspective view of the collapsible gas grill 100 with a hood 1100 in an open configuration; FIG. 1B shows a perspective view of the collapsible gas grill 100 with the hood 1100 in a closed configuration; FIG. 1C shows a back view of the collapsible gas grill 100 with the hood 1100 in the closed configuration; and FIG. 1D shows a side view of the collapsible gas grill 100 in the collapsed configuration. The grill 100 comprises the hood 1100, a bowl 1200, a base 1300 and a control panel 1400.

The hood 1100 may include a pair of front hinges 1110, a pair of rear hinges 1140, an engaging lip 1170 and a handle 1180. The front hinges 1110 may be connected to the hood 1100 by means of an upper front fastening mechanism 1120 (e.g., a rivet, a screw, a bolt-nut combination, a pin, or the like) and connected to the bowl 1200 by means of a lower front fastening mechanism 1130 (e.g., a rivet, a screw, a bolt-nut combination, a pin, or the like). The rear hinges 1140 may be connected to the hood 1100 by means of an upper rear fastening mechanism 1150 (e.g., a rivet, a screw, a bolt-nut combination, a pin, or the like) and connected to the bowl 1200 by means of a lower rear fastening mechanism 1160 (e.g., a rivet, a screw, a bolt-nut combination, a pin, or the like). The engaging lip 1170 may be configured to cover and engage a perimeter lip 1270 of the bowl 1200 to reduce, for example, the escape of heat, gases, smell, or the like, from the chamber formed by the hood 1100 and bowl 1200.

The bowl 1200 may include a plurality of supports configured to support the cooking grid(s) 1210 and a rotating latch mechanism 1230 for locking the hood 1100 to the bowl 1200, for example, when collapsing and storing the grill 100. The cooking grid(s) 1210 may be fastened to the bowl 1200, so as to maintain the cooking grid(s) 1210 in a substantially fixed position relative to the bowl 1200 during collapsing and/or transporting of the grill 100. The bowl 1200 may further include a catch and gate mechanism 1250 provided on the underside of the bowl 1200 and configured to receive and lock a portion (e.g., a loop on an upper most part of the legs 1320) of the base 1300, i.e., a portion of the legs 1320. A portion of the catch and gate mechanism 1250 may be coupled to the rotating latch mechanism 1230, so as to be releasable by actuation of the rotating latch mechanism 1230. The bowl 1200 may also include a hinge mechanism 1240 that is provided on the underside of the bowl 1200 and configured to pivotally attach to another portion of the base 1300, i.e., a portion of the legs 1310. The bowl 1200 may further include a

The catch and gate mechanism 1250 may include, for example, the catch and gate mechanism disclosed in U.S. Pat. No. 6,439,221, which is herein incorporated by reference, or any other mechanism that will provide for secure engagement of the bowl 1200 to the base 1300 in the collapsed configuration, so as to keep the base 1300 substantially rigidly affixed to the bowl 1200 when the grill 100 is in the collapsed configuration and the catch and gate mechanism 1250 is engaged.

The bowl 1200 may be configured to engage and/or hold a drip cup 1280, as seen in FIG. 1C. The drip cup 1280 may be configured to receive, for example, fluids or solids such as, for example, fat, water, or the like that may be released by the cook items while cooking.

The base 1300 may include legs 1310, 1320, as seen in FIG. 1, wherein the legs 1320 may be provided with wheels 1330 for easy mobility of the grill 100. For example, in its collapsed configuration, the grill 100 may be easily moved and maneuvered by grabbing the handle 1430 and pushing or pulling the grill 100 while it rolls on the wheels 1330. Further, the legs 1320 may be provided with a cross-brace member 1340 for added stability and strength, as well as lockably engaging the catch and gate mechanism 1250 in the collapsed configuration. The legs 1310, 1320 are configured to collapse into a position substantially parallel with the surface plane of the bowl 1200 underside, such that the grill 100 folds very flat (as shown, for example, in FIG. 1D). In the collapsed configuration, the cross-brace member 1340 may engage and lock in the catch and gate mechanism 1250 for, e.g., secure stowing, transport, and the like. To assemble the grill 100, the cross-brace member 1340 may be released by manipulating the rotating latch mechanism 1230, which causes the catch and gate mechanism 1250 to release the cross-brace member 1340.

According to an aspect of the disclosure, the legs 1320 may be configured to be longer than the legs 1310, such that the legs 1320 extend beyond the wheels 1330, so that the grill 100 may roll when in the collapsed configuration and tilted, but rest on the legs 1320 when positioned near an upright position.

The control panel 1400 may include a plurality of control knobs 1410, 1420, a handle 1430, a regulator 1440, and one or more valves 1445 (shown in FIGS. 6, 7). The handle 1430 may be configured for hanging the grill 100 to a fixed support (e.g., a wall mount). The regulator 1440 may be configured to attach to a gas supply 1490 (e.g., a gas bottle, a propane bottle, a hose and gas bottle, a household gas supply line or the like).

The hood 1100, bowl 1200 and control panel 1400 are configured such that the various components of the grill 100 do not separate when the grill 100 is not horizontal, such as, for example, when the grill 100 is collapsed and hung on, e.g., a support or transported via the handle 1180 and/or the handle 1430, including, e.g., the cooking grid 1210.

The grill 100 may be collapsed by manipulating the rotating latch 1230, which causes the catch and gate mechanism 1250 to release the upper portion of the legs 1320. The legs 1320 may then be pivoted until they are substantially parallel with the legs 1310. Then, the legs 1310 and 1320 may be pivoted as a group about the pivot axis of the hinges 1240 until the legs 1310 and 1320 are substantially parallel to the surface plane of the bowl 1200 (as shown, e.g., in FIG. 1D). The cross-brace member 1340 may then be engaged and locked into the catch and gate mechanism 1250, thereby fixedly holding the group of legs 1310, 1320 in the position substantially parallel to the surface plane of the bowl 1200. To assemble the grill 100, the foregoing process may be reversed, except that the rotating latch 1230 would be manipulated to cause the catch and gate mechanism 1250 to release the cross-brace member 1340 before manipulating the legs 1310, 1320.

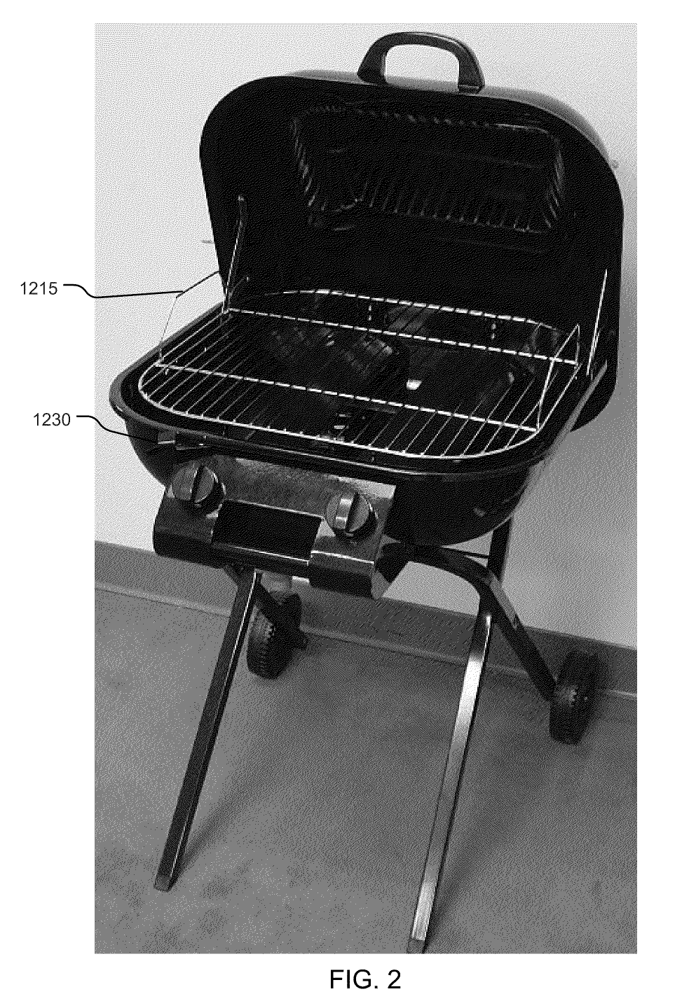

FIG. 2 shows a perspective top-front view of the collapsible gas grill 100. As seen in FIG. 2, the cooking grill 1210 may include handles 1215. The handles 1215 may be configured to engage or rest against inner portions of the hood 1100 when the hood 1100 is closed, so as to keep the cooking grill 1210 relatively fixed with regard to the hood 1100 and bowl 1200 during collapsing, age, transport, or the like.

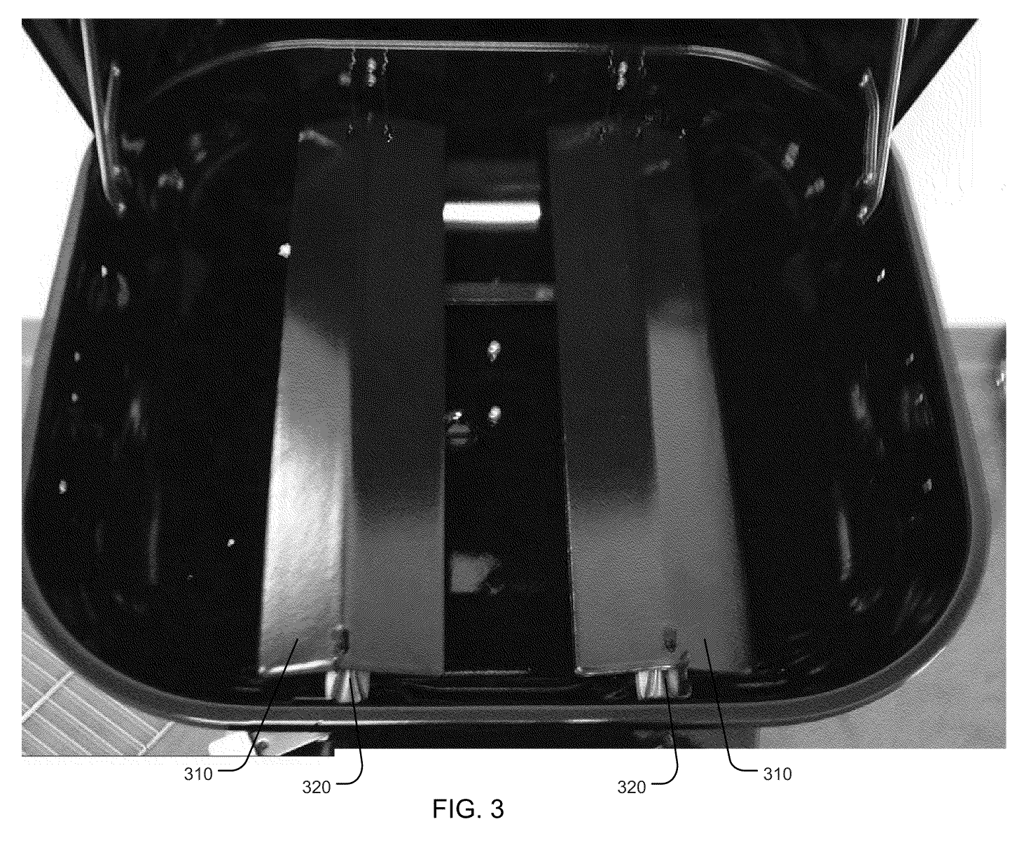

FIG. 3 shows a top view of the bowl 1200, including a pair of burners 320, to which flavor activators 310 may be affixed, according to principles of the disclosure. The burners 320 and flavor activators 310 may be fastened to the bowl 1200, so as to keep the burners 320 and flavor activators relatively fixed with regard to the bowl 1200 during collapsing, storage, transport, or the like. The burners 320 may be fastened to the bowl 1200 at one distal end of each burner 320, and to the control panel 1400 at the opposite distal end of each burner 320. For instance, the burners 320 may be coupled to the outlets of the valves 1445, as shown in FIGS. 6 and 7. The flavor activators 310 may be attached to the burners 320 and/or the bowl 1200.

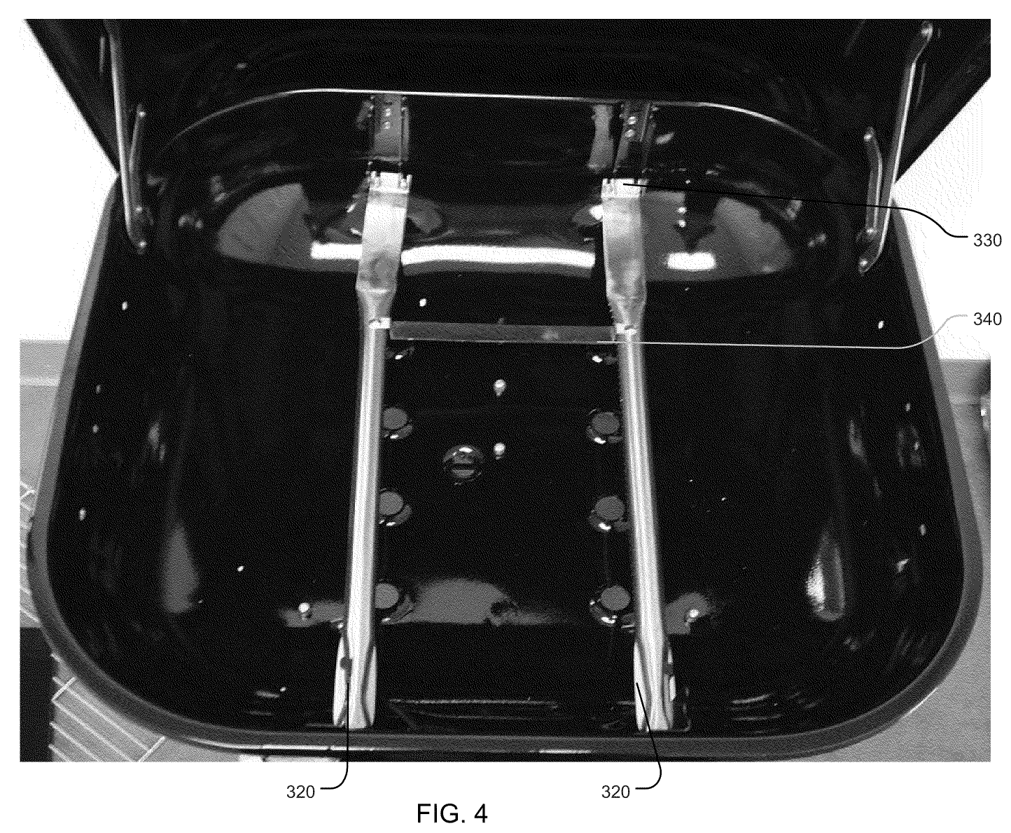

FIG. 4 shows a top view of the bowl 1200, with the plurality of flavor activators 310 removed. As seen in FIG. 4, the burners 320 may include longitudinal burners, each of which may include a flat portion 330 that may be rigidly affixed to an inside wall of the bowl 1200. For added rigidity and strength, a cross-burner member 340 may be provided between the burners 320.

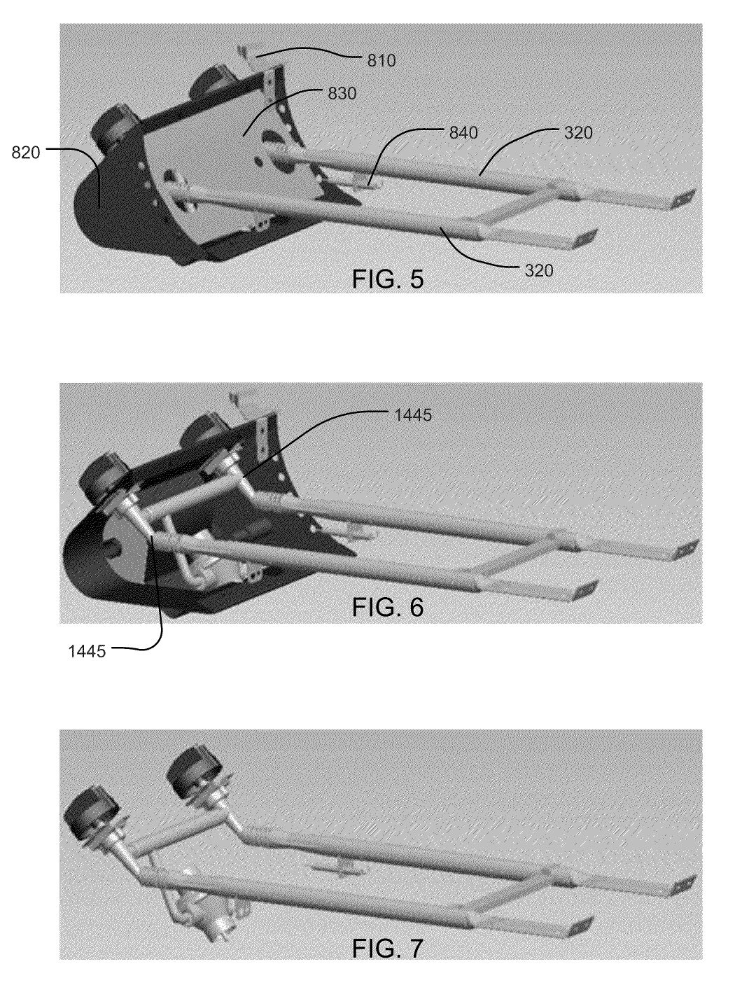

FIG. 5 shows a perspective side view of an example of the control panel 1400 and burners 320 that may be used in the collapsible gas grill 100, according to principles of the disclosure. The control panel 1400 may include a bracket 810 that is configured to affix the control panel 1400 to the bowl 1200. The control panel 1400 may further include a housing 820 (that may be coupled to the bracket 810) that is configured to hold the various components of the control panel 1400 in position and to provide aesthetic appeal. The control panel 1400 may further include a heat shield 830 that may be placed between the housing 820 and the bowl 1200 to minimize the conductance of heat from the bowl 1200 to the handle 1430, knobs 1410, 1420, and/or the surfaces of the control panel 1400. An igniter 840 may be coupled to at least one of the longitudinal burners 320.

FIG. 6 shows a perspective side view of the example of the control panel 1400 and burners 320 shown in FIG. 5, with the heat shield 830 and a portion of the control panel housing 820 removed.

FIG. 7 shows a perspective side view of the example of the control panel 1400 and burners 320 shown in FIGS. 5 and 6, with the control panel housing 820 and heat shield 830 completely removed.

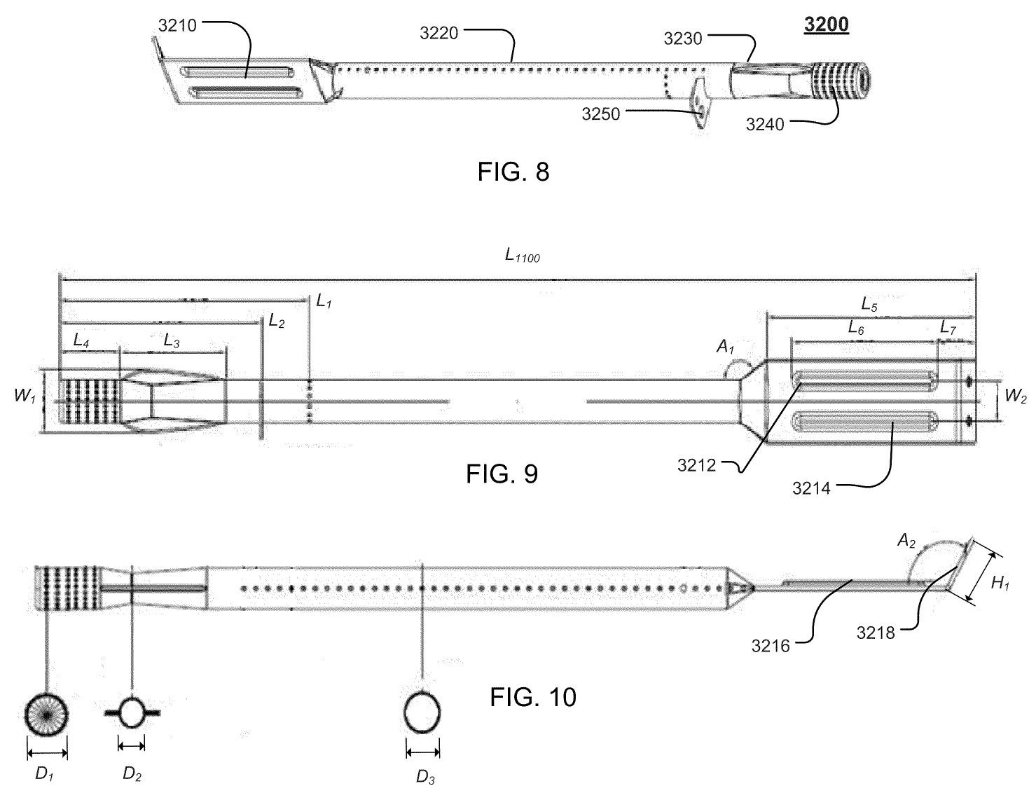

FIG. 8 shows a perspective view of an embodiment of a longitudinal burner 3200, which may be used with the collapsible gas grill 100 shown in FIG. 1, according to principles of the disclosure. As seen in FIG. 8, the burner 3200 may include a flat portion 3210, a tubular portion 3220, a constricted portion 3230, an inlet portion 3240 and a support portion 3250. The portions 3210 to 3250 ray be integrally formed from a single material (such as, e.g. aluminum, cast iron, iron, steel, ceramic, or the like) such as, e.g., in a common mold. Alternatively, the portions 3210 to 3250, or a subset thereof, may be assembled from one or more individual components. The longitudinal burner 3200 may comprise the shape shown in FIG. 8. Further, the longitudinal burner 3200 may comprise various exemplary dimensions.

FIG. 9 shows a top view of the longitudinal burner 3200. As seen in FIG. 9, the longitudinal burner 3200 may have a length L₁₁₀₀. The flat portion 3210 may have a length L₅, where L₅ may equal, for example, approximately the length L₁₁₀₀ multiplied by a factor of about 0.23 (L₅=0.23L₁₁₀₀). The flat portion 3210 may include dual fastening channels 3212, 3214 for receiving a fastening mechanism (not shown), such as, e.g., a bolt, a screw, a rivet, or the like, to fasten the burner 3200 to, e.g., the chassis (or bowl 1200) of the collapsible gas grill 100 (shown in FIG. 1). The fastening channels 3212, 3214 bray have a length L₆, where L₆ may equal, for example, approximately the length L₁₁₀₀ multiplied by a factor of about 0.16 (L₆=0.16L₁₁₀₀). The fastening channels 3212, 3214 may be spaced apart from each other by a width W₂, where W₂ may equal, for example, approximately the length L₁₁₀₀ multiplied by a factor of about 0.036 (W₂=0.036L₁₁₀₀). A length L₇ from an edge of the fastening channels 3212, 3214 to an edge of the flat portion 1110 may equal, for example, approximately the length L₁₁₀₀ multiplied by a factor of about 0.04 (L₇=0.04L₁₁₀₀). An angular section of the flat portion 3210 may have an angle A₁ as seen in FIG. 9.

At the other distal end of the longitudinal burner 3200, the constricted portion 3230 may have a length L₃ and a width W₁, where L₃ may equal, for example, approximately the length L₁₁₀₀ multiplied by a factor of about 0.12 (L₃=0.12L₁₁₀₀), and W₁ may equal, for example, approximately the length L₁₁₀₀ multiplied by a factor of about 0.057 (W₁=0.057L₁₁₀₀). The inlet portion 3240 may have a length L₄, where L₄ may equal, for example, approximately the length L₁₁₀₀ multiplied by a factor of about 0.06 (L₄=0.06L₁₁₀₀). The lengths L₁ and L₂, shown in FIG. 9, may equal, for example, approximately the length L₁₁₀₀ multiplied by a factor of about 0.27 and about 0.22, respectively (L₁=0.27L₁₁₀₀ and L₂=0.22L₁₁₀₀). Of course, other values for L₁ to L₇, L₁₁₀₀, W₁, W₂, and A₁ may be implemented without departing from the scope or spirit of the disclosure. The disclosure is in no way limited to the illustrative examples of lengths, widths and angles provided herein.

FIG. 10 shows a side view of the longitudinal burner 3200. As seen in FIG. 10, the flat portion 3210 includes a longitudinal section 3216 and an inclined section 3218. The longitudinal section 3216 and the inclined section 3218 form an angle A₂, as seen in FIG. 10. The longitudinal burner 3200 has a diameter of D₁ in the inlet portion 3240, a diameter D₂ at the narrowest point in the constricted portion 3230, and a diameter D₃ in the tubular portion 3220.

A non-limiting example of possible dimensions for L₁ to L₇, L₁₁₀₀, W₁, W₂, A₁, A₂, H₁, D₁, D₂, and D₃, for the longitudinal burner 1100, may include, for example: L₁=about 135.2 mm; L₂=about 109.6 mm; L₃=about 57.4 mm; L₅=about 113.1 mm; L₆=about 78.9 mm; L₇=about 20.6 mm; L₁₁₀₀=about 495.6 mm; W₇=about 28.4 mm; W₂=about 18 mm; H₁=about 17.7 mm; A₁=about 147 degrees; A₂=about 120 degrees; D₁=D₃ about 19.1 mm; and D₂=about 14.1 mm.

While the disclosure has been described in terms of exemplary embodiments, those skilled in the art will recognize that the disclosure can be practiced with modifications in the spirit and scope of the appended claims. These examples given above are merely illustrative and are not meant to be an exhaustive list of all possible designs, embodiments, applications or modifications of the disclosure.

What is claimed:

1. A collapsible gas grill having a control panel, a bowl and a hood, the collapsible gas grill comprising:
a cooking grid that supports a cooking item;
a burner attached to the bowl, the burner being configured to provide heat to the cooking grid, the burner being attached to the bowl;
a valve attached to the control panel, the valve being configured to control supply of gas to the burner;
a rotating latch that locks the hood to the bowl;
a base that supports the grill; and
a catch that engages the base when the collapsible gas grill is in one of a collapsed configuration or an open configuration,
wherein the catch and gate is coupled to the rotating latch.

2. The collapsible gas grill according to claim 1, wherein the base comprises:
a plurality of legs configured to collapse substantially parallel with a surface plane of the bowl.

3. The collapsible gas grill according to claim 1, wherein the burner comprises a longitudinal burner that is configured to rigidly attach to an inner wall of the bowl.

4. The collapsible gas grill according to claim 3, wherein the longitudinal burner comprises:
an inlet portion that is configured to receive gas supply from a valve;
a tubular portion that is configured to receive gas supply from the inlet portion and release gas through a plurality of orifices; and
a flat portion that is configured to be attached to an inner wall of the bowl.

5. The collapsible gas grill according to claim 2, wherein the plurality of legs comprise:
a pivoting set of legs that are coupled to a first portion of the bowl; and
a releasable set of legs that are configured to engage the catch.

6. The collapsible gas grill according to claim 5, wherein the releasable set of legs comprise an upper portion and a cross-member,
the upper portion being configured to engage the catch when the collapsible gas grill is in the open configuration, and
the cross-member being configured to engage the catch when the collapsible gas grill is in the collapsed configuration.

7. The collapsible gas grill according to claim 1, wherein the control panel includes a handle.

8. The collapsible gas grill according to claim 1, further comprising:
a gate that secures the base to the catch when the collapsible gas grill is in one the collapsed configuration or the open configuration.

9. A collapsible gas grill having a bowl and a hood, comprising:
a burner rigidly affixed to the bowl; and
a plurality of legs configured to collapse substantially parallel with a surface plane of the bowl.

10. The collapsible gas grill according to claim 9, further comprising:
a control panel that includes a handle.

11. The collapsible gas grill according to claim 9, wherein the burner comprises:
a longitudinal burner that is configured to rigidly attach to an inner wall of the bowl.

12. The collapsible gas grill according to claim 9, further comprising:
a rotating latch configured to lock the hood to the bowl.

13. The collapsible gas grill according to claim 12, further comprising:
a catch that is configured to receive either a portion of one of the plurality of legs or a cross-bar member,
wherein the catch is coupled to the rotating latch.

14. The collapsible gas grill according to claim 13, wherein the plurality of legs comprise:
a pair of pivoting legs that are attached to a side of the bowl; and
a pair of releasable legs that are configured to engage the catch.

15. The collapsible gas grill according to claim 11, wherein the longitudinal burner comprises:
an inlet portion that is configured to receive gas supply from a valve;
a tubular portion that is configured to receive gas supply from the inlet portion and release gas through a plurality of orifices; and
a flat portion that is configured to be attached to an inner wall of the bowl.

16. The collapsible gas grill according to claim 15, further comprising:
a regulator that is configured to supply gas from a gas supply source to the valve.

17. The collapsible gas grill according to claim 9, further comprising:
a flavor activator that is attached to at least one of the burner and an inner wall of the bowl.

18. A method of providing a collapsible gas grill, the method comprising:
providing a bowl having front and rear portions;
affixing a control panel to the bowl;
pivotally attaching the bowl to a first set of legs;
pivotally attaching a second set of legs to the first set of legs;
providing a loop on an upper portion of the second set of legs; and
providing a catch on the rear portion of the bowl to engage the loop,
wherein the first set of legs and the second set of legs are configured to collapse into a position substantially parallel with a surface plane of an underside of the bowl when the collapsible grill is configured in a collapsed configuration.

19. The method according to claim 18, further comprising:
affixing a longitudinal burner to an inner wall of the bowl; and
coupling the longitudinal burner to a valve.

20. The method according to claim 18, further comprising:
affixing a rotating latch that is configured to lock a hood to the bowl.
